(19) United States
(12) Patent Application Publication
(10) Pub. No.: US 2025/0106105 A1
(43) Pub. Date: Mar. 27, 2025

(54) CONFIGURING FOR MOBILE RELAY NODES WITH USER PLANE FUNCTIONS

(71) Applicant: ZTE Corporation, Shenzhen (CN)

(72) Inventors: Xueying DIAO, Shenzhen (CN); Ying HUANG, Shenzhen (CN); Lin CHEN, Shenzhen (CN); Tao QI, Shenzhen (CN)

(73) Assignee: ZTE Corporation, Shenzhen, GD (CN)

(21) Appl. No.: 18/901,893

(22) Filed: Sep. 30, 2024

Related U.S. Application Data
(63) Continuation of application No. PCT/CN2022/088317, filed on Apr. 21, 2022.

(51) Int. Cl. H04L 41/082; H04L 45/74

(52) U.S. Cl. CPC H04L 41/082; H04L 45/74

(57) ABSTRACT

Presented are systems, methods, apparatuses, or computer-readable media for configuring mobile relay nodes. A first network node may send, to a second network node, configuration information. The configuration information may be associated with a node capable of providing at least one user plane (UP) function.

### TECHNICAL FIELD

The disclosure relates generally to wireless communications, including but not limited to systems and methods for configuring mobile relay nodes with user plane (UP) functions.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, a method, an apparatus, or a computer-readable medium for configuring mobile relay nodes. A first network node may send, to a second network node, configuration information. The configuration information may be associated with a node capable of providing at least one user plane (UP) function.

In some embodiments, the at least one UP function may include a gNB centralized unit UP (gNB-CU-UP) function. In some embodiments, the second network node may include at least one of: the node, a mobile termination (MT) function of the node, a distributed unit (DU) function of the node, or a UP function of the node.

In some embodiments, the first network node may receive, from the second network node, first information comprising at least one of: an indication of the second network node which is a mobile node; an indication or a capability of the second network node to provide the at least one UP function; or a number of UP function modules localized in the second network node.

In some embodiments, a parent node of the second network node may broadcast information on the first network node's capability of supporting communication with the node capable of providing the at least one UP function, or information on allowing access of the node capable of providing the at least one UP function.

In some embodiments, the first network node may send, to the second network node, the first network node's capability of supporting communication with the node capable of providing the at least one UP function, or info on allowing access of the node capable of providing the at least one UP function. In some embodiments, the first network node may send, to a third network node, the second network node's capabilities which include whether the at least one UP function is supported. In some embodiments, the first network node may receive, from the third network node, an indication of whether the second network node is authorized to provide of support the at least one UP function.

In some embodiments, the first network node may exchange, with the third network node before, after or during integration of the second network node, capabilities that include whether the first or third network node can serve the node capable of providing the at least one UP function. In some embodiments, the third network node may exchange, with the fourth network node before, after or during the integration of the second network node, capabilities that include whether the third or fourth network node can serve the node capable of providing the at least one UP function.

In some embodiments, the first network node may establish or modify a backhaul (BH) radio link control (RLC) for carrying traffic between the first network node and a UP function of the second network node. In some embodiments, the first network node may configure a backhaul adaptation protocol (BAP) routing identifier (ID) for traffic between the first network node and the UP function of the second network node.

In some embodiments, traffic between the first network node and the UP function of the second network node may be transferred using the BH RLC channel and the BAP routing ID used for non-UP traffic or uplink non-UP traffic. In some embodiments, a traffic type of the non-UP traffic may include at least one of: UE-associated F1 application protocol (F1AP), non-UE-associated F1AP, non-F1, BAP control PDU, UE-associated E1 application protocol (E1AP), non-UE-associated E1AP, or non-E1. In some embodiments, the traffic between the first network node and the UP function of the second network node may include at least of: non-UP traffic, E1 traffic, or non-E1 traffic.

In some embodiments, the first network node may receive, from the second network node, a request for at least one IP address. The request may be for each of a plurality of usages comprising at least one of: all traffic, F1 user plane interface (F1-U) traffic, F1 control plane interface (F1-C) traffic, non-F1 traffic, non-E1 traffic, E1 traffic, or user plane traffic via an NG-U interface. In some embodiments, the first network node may send, to the second network node, at least one of: one or more IPv6 addresses or one 64-bit IPv6 prefix for each of the usages, or one or more IPv4 addresses for each of the usages.

In some embodiments, the first network node may receive, from the second network node, at least one of: a number of IP addresses requested, or a number of IP addresses used for each of a plurality of usages. In some embodiments, the first network node may receive a backhaul adaptation protocol (BAP) address via a message from a UP function of the second network node.

In some embodiments, the first network node may send, to the second network node, an IP address of the first network node. In some embodiments, the first network node may send, to the second network node, a backhaul (BH) configuration for traffic between the first network node and the UP function of the second network node.

In some embodiments, the first network node may receive, from the second network node, a first message comprising at least one of: an F1 user plane interface (F1-U) uplink (UL) tunnel endpoint identifier (TEID) or a transport layer address. In some embodiments, the first network node may send, to the UP function of the second network node, a second message comprising at least one of: a F1-U DL TEID or a transport layer address.

In some embodiments, the first network node may send quality-of-service (QoS) flow level QoS parameters of the backhaul (BH) radio link control (RLC) channel. In some embodiments, a protocol data unit (PDU) session and a BH RLC channel may have a one-to-one mapping or a many-to-one mapping. In some embodiments, the first network node may send to the second network node, uplink backhaul (BH) information. The uplink BH information may include at least one of a backhaul adaptation protocol (BAP) routing identifier (ID), a next-hop BAP address, or an ID of an egress BH RLC channel.

In some embodiments, the first network node may send, to a third network node, a message with information comprising at least one of: a mapping between an IP security (IPsec) transport layer address and a list of an uplink or downlink GPRS tunneling protocol (GTP) transport layer address; or at least one of an IP address, a differentiated services code point (DSCP) or a flow label configuration, on each protocol data unit (PDU) session or GTP tunnel between an UP function of the second network node and a core network. In some embodiments, the information may be sent from a third network node to a fourth network node. The third network node and the fourth network node each may be a network function or an entity of the core network.

In some embodiments, the first network node may send to a third network node, information comprising at least one of: an identity of the second network node or a user equipment (UE), an indication of a second network node which is a mobile node, an indication or a capability of the second network node to provide the at least one UP function, or a number of UP function modules localized in the second network node. In some embodiments, the first network node may receive, from the second network node or the third network node, an indication to inform the first network node of successful access by the second network node.

In some embodiments, the first network node may send to a fourth network node via a fifth network node or may send to the fifth network node at least one of: an identity of the second network node or a user equipment (UE), uplink or downlink TNL information, quality-of-service (QoS) mapping information, or an identity of a PDU session.

In some embodiments, the uplink or downlink TNL information may include at least one of: previous GPRS tunneling protocol (GTP) transport layer address information, new GTP transport layer address information, new IPsec TNL address, previous IPsec TNL address, or a mapping between an IPsec TNL address and a list of GPRS tunneling protocol (GTP) addresses. In some embodiments, the previous or new GTP transport layer address information may include at least one of: an IP address or a GPRS tunneling protocol (GTP) tunnel endpoint identifier (TEID). In some embodiments, the QoS mapping information may include an IP address or differentiated services code point (DSCP) or flow label values.

In some embodiments, the first network node may send, to a third network node, a message including information comprising at least one of: a traffic index, which associates with a packet data unit (PDU) session or a PDU session identifier or an uplink or downlink TNL information, an identity of a PDU session, or the uplink or downlink TNL information. In some embodiments, the TNL information may include at least one of: an IP address, a tunnel endpoint identifier (TEID), or a port number.

In some embodiments, the first network node may send, to a second network node, at least one of: at least one IP address, an indication that an IP address is to be used by the second network node to establish an E1 connection with a third network node, an indication that the IP address is allocated by a third network node, a backhaul adaptation protocol (BAP) address allocated by the third network node, an indication that the BAP address is allocated by a third network node, or a BAP address of a fourth network node controlled by the third network node.

In some embodiments, the first network node may configure, to the second network node, at least one of: a backhaul adaptation protocol (BAP) address, or an indication that a packet with the BAP address is communicated to or from the UP function to establish an E1 connection with a third network node.

At least one aspect is directed to a system, a method, an apparatus, or a computer-readable medium for configuring mobile relay nodes. A second network node may receive, from a first network node, configuration information. The configuration information may be associated with a node capable of providing at least one user plane (UP) function.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 depicts a block diagram of an example of a network deployed with integrated access and backhaul links, in accordance with an illustrative embodiment;

FIG. 4 depicts a block diagram of an example of a protocol stack of integrated access and backhaul (IAB)-node with a user plane (UP) function, in accordance with an illustrative embodiment;

FIG. 5 depicts a block diagram of an integrated access and backhaul (IAB)-node with F1-U interface between a distributed unit (DU) and a user plane (UP), in accordance with an illustrative embodiment;

FIG. 6 depicts a block diagram of an integrated access and backhaul (IAB)-node with direct connection between a distributed unit (DU) and a user plane (UP), in accordance with an illustrative embodiment;

FIG. 7 depicts a communication diagram of a process for a user equipment (UE) to access an integrated access and backhaul (IAB)-node, in accordance with an illustrative embodiment;

FIG. 8A depicts a block diagram of a process of a partial migration of a mobile integrated access and backhaul (IAB)-node without a user plane (UP) function, in accordance with an illustrative embodiment;

FIG. 8B depicts a block diagram of a process of a partial migration of a mobile integrated access and backhaul (IAB)-node with a user plane (UP) function, in accordance with an illustrative embodiment;

FIG. 9 depicts a block diagram of a process of a full migration of a mobile integrated access and backhaul (IAB)-node with a user plane (UP) function, in accordance with an illustrative embodiment; and

FIGS. 10A-E depicts a process diagram of a method of configuring mobile relay-nodes, in accordance with an illustrative embodiment.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 1. Mobile Communication Technology and Environment

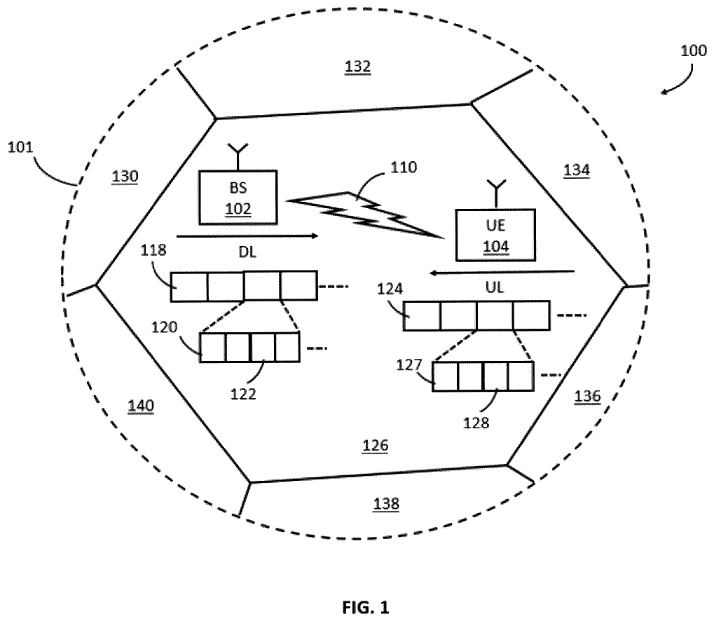

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

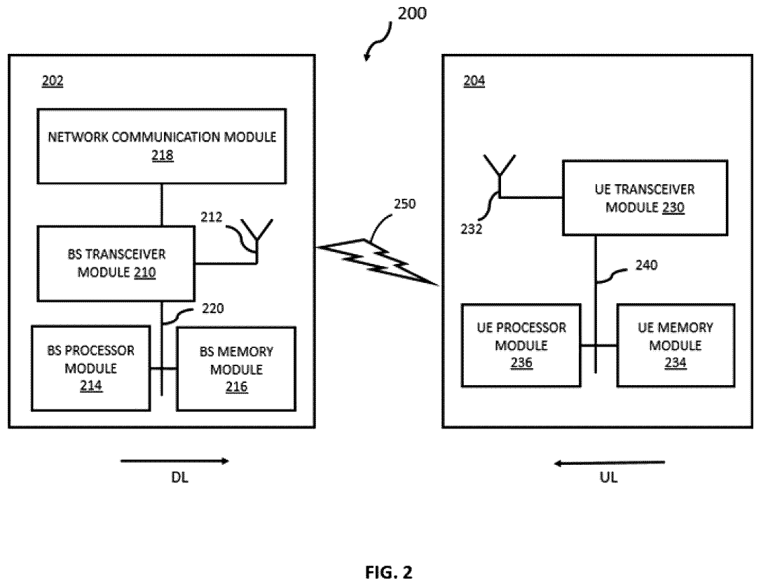

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

### 2. Systems and Methods for Mobile Relay Nodes with User Plane (UP) Functions

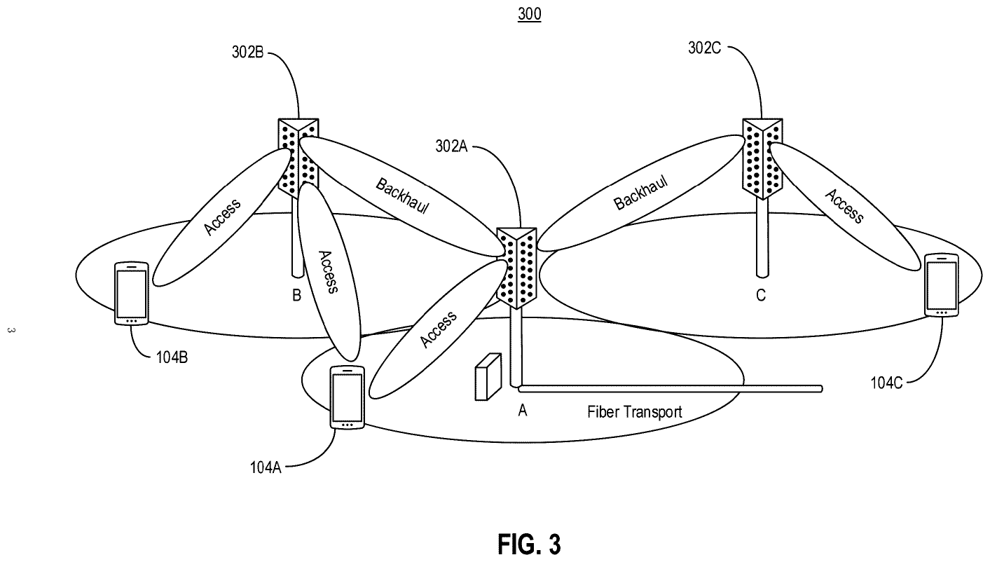

Referring to FIG. 3, depicted is an example of a network deployed with integrated access and backhaul links. In this example, three nodes 302 (e.g., access nodes accessed directly by one or more UEs 104), such as nodes A, B, and C (e.g., nodes 302A, 302B, and 302C), and three UEs 104 (e.g., UE 104A, UE 104B, and UE 104C) may be shown in FIG. 3. The nodes 302 may include or be referred to generally as a network node. In some cases, the nodes 302 can include or correspond to integrated access and backhaul (IAB) nodes. Each node 302 may correspond to at least one of an access node (e.g., a node 302 providing access to the UE 104) and, or a donor node (e.g., another node with a wired connection, such as for fiber transport, communicative to the access node via backhaul link). In some cases, the access node may correspond to a donor node, such as if the UE 104 connects directly to a node with fiber transport. The nodes 302 may include one or more features or functionalities similar to the BS 102 (or BS 202), such as described in conjunction with FIGS. 1-2. Individual UEs 104 can access a respective node A, B, C through an access link. For instance, UE 104A can access node 302A, UE 104B can access node 302B, and UE 104C can access node 302C via a respective access link.

In this example, a wired connection may be provided, included, implemented between the access node A (e.g., node 302A) and a core network, and the access nodes B and C may not include or be implemented with a wired connection with the core network element. In this case, the access node that supports the wireless access of the UE 104 and, or transmits data, information wirelessly may include, correspond to, or be referred to as an IAB node. The access node providing the wireless backhaul feature, function for the IAB node, such that the UE 104 can connect to and, or communicate with the core network (e.g., via fiber transport), may be called, referred to as an IAB donor (e.g., sometimes referred to generally as donor node or network node). In this example, access node A may be a donor node providing access to the core network to one or more UEs 104 accessing access nodes A or B.

The UE 104 can transmit data between the access nodes (e.g., node B to node A or node C to node A) through the wireless backhaul link. For example, the access node B may provide, transmit, or send the data or information received, obtained, or acquired from the UE 104 to the access node A through a wireless backhaul link (e.g., a first wireless backhaul link). The access node A, responsive to receiving the data from the access node B, can send/transmit the UE data to the core network element via fiber transport or the wired connection. For the downlink, the core network element may send the UE data packet (e.g., response packet or downlink packet) to the access node A. The access node A may receive the UE data from the core network. Responsive to the reception, the access node A can transmit the UE data to the access node B coupled to the UE 104 via or through the wireless backhaul link. Accordingly, the access node B can provide, send, or transmit the UE data through the access link to the respective UE 104.

However, in certain systems, wireless backhaul (BH) links, connections may be vulnerable, or exposed to blockage, for instance, due to moving objects such as vehicles, seasonal changes (e.g., foliage, rain, snow, climate, etc.), or infrastructure changes (e.g., new buildings, landscape alteration, etc.). The systems and methods discussed herein can address the situations, scenarios of any blockage, disconnection of the BH links between IAB nodes. For example, an IAB-node (e.g., network node) can migrate, transfer, or move to another IAB-donor (e.g., an IAB-donor connected to a core network), perform, or initiate radio resource control (RRC) re-establishment with another IAB-donor. Further, for IAB-nodes operating in a standalone (SA) mode, new radio (NR) dual connectivity (DC) can be used to enable, activate, perform route redundancy in the BH by allowing the IAB-mobile termination (MT) to have concurrent or multiple BH links with at least two parent nodes. The parent nodes may be connected, established to the same or to different IAB-donor-CUs. The one or more IAB-donor-CUs can control the establishment and, or release of redundant routes via the one or more parent nodes. In this example, inter-topology transport can be used, implemented, performed, executed, or provided. The system and methods discussed herein can improve the information exchanged between IAB-donors to support inter-topology transport. Further, the systems and methods discussed herein can support inter-donor-DU re-routing, among other features or functionalities for re-routing communications between different IAB-nodes.

As demand for improved 5G cellular coverage and connectivity continues to increase, it may be challenging in many outdoor and mobility scenarios. In some outdoor environments, the availability of vehicles equipped with mobile base station relays, either following a certain known, predictable itinerary (e.g. buses, trams, etc.), or situated in convenient locations (e.g. outside stadiums, hot-spot areas, or emergency sites), may provide very opportunistic boost to cellular coverage and capacity. Those relays, using 5G wireless backhaul toward the macro network, may offer better 5G coverage and connectivity to neighboring UEs. IAB-node can forward data by using 5G wireless backhaul toward the macro network. As such, mobile-IAB (or VMR-nodes), e.g., mounted on one or more mobile platforms, to provide 5G coverage or capacity enhancement to onboard and, or surrounding UEs.

As discussed herein, an IAB-donor (sometimes referred to as a donor node) may include or correspond to any network node connected to a core network. Further, an IAB-node may include or correspond to any mobile node, such as a mobile IAB-node or a mobile BS relay or a vehicle-mounted relay, among others.

The IAB-node may connect to an upstream IAB-node or an IAB-donor-DU via a subset of the UE functionalities of the new radio (NR) Uu interface, referred to as a IAB-mobile termination (MT) function of IAB-node. The IAB-node may provide wireless backhaul to the downstream IAB-nodes and UEs via the network functionalities of the NR Uu interface, referred to as a IAB-DU function of IAB-node. The F1-C (e.g., for control plane) traffic between an IAB-node and IAB-donor-CU may be backhauled via the IAB-donor-DU and the intermediate hop IAB-node(s). In addition, the F1-U (e.g., for user plane) traffic between an IAB-node and IAB-donor-CU is backhauled via the IAB-donor-DU and the optional intermediate hop IAB-node(s).

Presented herein is a IAB-node architecture including IAB-MT, IAB-DU and IAB-UP. Different from above described IAB-node, the IAB-node architecture can provide the UP functionalities or CU-UP functionalities. With these functionalities, the signaling overhead and user plane transport latency can be reduced a lot during IAB-node migration or other IAB-node mobility cases.

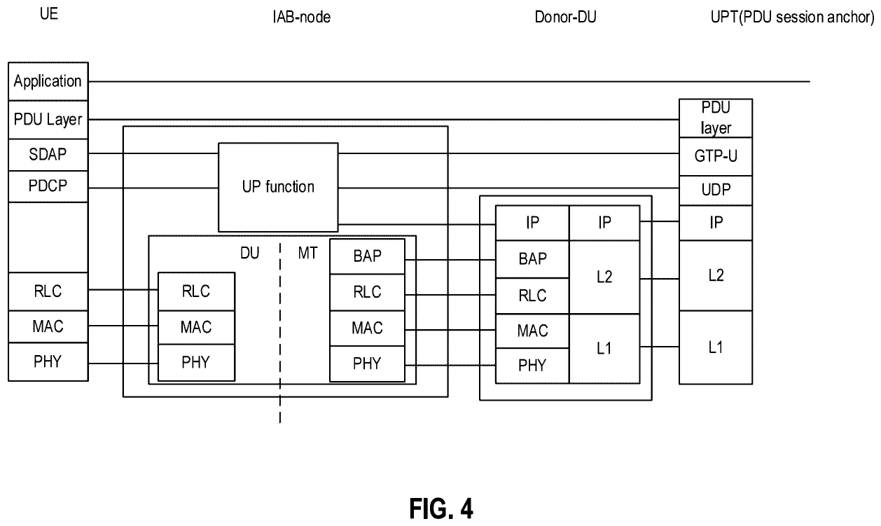

Referring now to FIG. 4, depicted is an example of a protocol stack of the IAB-node with UP function. The UP function localized in the IAB-node can be referred to as IAB-UP. IAB-UP may be able to retrieve the SDAP SDU and deliver it to GTP-U layer. IAB-UP may refer to gNB-CU-UP functionality supported by the IAB-node.

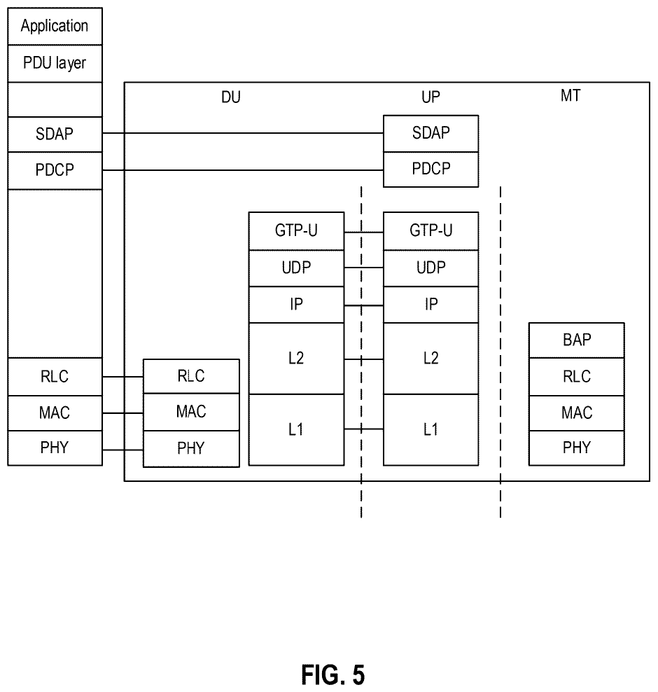

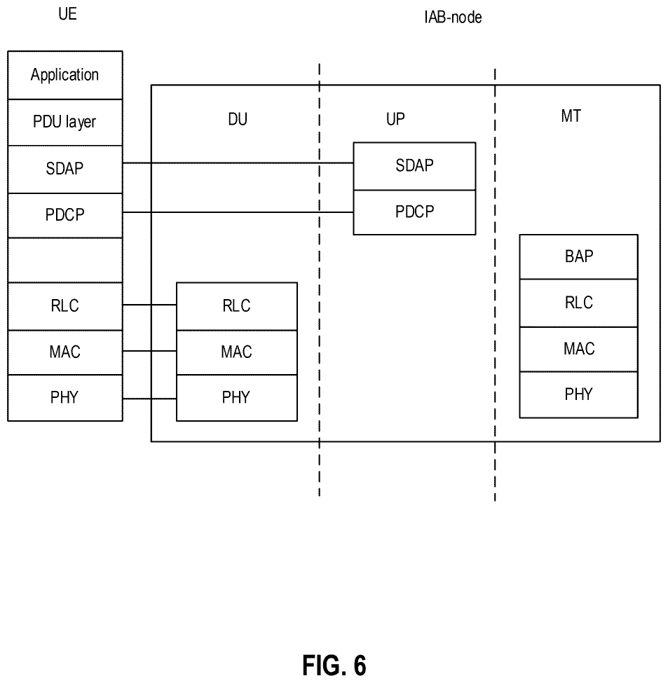

The IAB-UP may host the user plane part of the PDCP protocol, and the user plane part of the PDCP protocol and the SDAP protocol. The IAB-UP may terminate the E1 interface connected with the donor-CU-CP. The IAB-UP may terminate the F1-U interface connected with the co-located IAB-DU. The possible internal protocol stacks of IAB-node are discussed below in conjunction with FIGS. 5 and 6, where IAB-DU and UP function is connected via an F1-U interface as depicted in FIG. 5.

### A. Integration Procedure

Under phase 1, the IAB-MT setup may be performed. In this phase, the IAB-MT of the new IAB-node (e.g., the IAB-node 2 in an IAB node integration procedure) may connect to the network in the same way as a UE, by performing a radio resource control (RRC) connection setup procedure with the IAB-donor-CU. Authentication with the core network, IAB-node 2-related context management, IAB-node 2's access traffic-related radio bearer configuration at the RAN side (e.g., signaling radio bearers (SRBs) and data radio bearer (DRBs)) may also be performed. In some embodiments, the operations, administration, and maintenance (OAM) connectivity establishment by using the IAB-MT's protocol data unit (PDU) session.

The IAB-node can select the parent node for access based on an over-the-air indication from potential parent node IAB-DU (transmitted in SIB1). Information sent from IAB-MT to donor-CU may include at least one of: mobile IAB-node indication; the capability to provide UP functionalities; and the number of UPs localized in the IAB-node. The capability can be used to assist the IAB-donor to select an access and mobility function (AMF) supporting communication with an UP localized at an IAB-node.

IAB-node (e.g., the parent IAB-node or donor DU) may broadcast information about donor-CU's capability of supporting communication with a IAB-UP node. In some embodiments, the information may be on allowing access of the IAB-node that is capable of providing the UP function. The donor-CU may indicate to IAB-node about the Donor-CU's capability of supporting communication with IAB-UP, via RRC message. Donor-CU may indicate to AMF the IAB-node's capabilities including whether one or more UP functionalities is supported. AMF may indicate donor-CU about whether the IAB-node is authorized to provide or support UP functionalities. In some embodiments, the donor-CU and the AMF can exchange their capabilities of whether the AMF or the donor-CU can serve as the node capable of providing the one or more UP functionalities. The AMF and donor-CU may exchange their capabilities before or during or after IAB-node integration. The capabilities may identify whether the AMF or donor-CU can serve an IAB-node with one or more of the UP functionalities. In certain embodiments, the AMF and the UPF can exchange their capabilities of whether the AMF or the UPF can serve as the node capable of providing one or more UP functionalities. The AMF and UPF may exchange their capabilities before or during or after IAB-node integration. The capabilities may identify whether the AMF or UPF can serve an IAB-node with one or more of the UP functionalities.

Under phase 2-1, between IAB-MT and parent IAB-node, or IAB-MT and DU, backhaul (BH) radio link control (RLC) channel establishment may be performed. During the bootstrapping procedure, one BH RLC channel may be established to carry E1 traffic or E1AP messages or non-E1 traffic (e.g. stream control transmission protocol (SCTP) or IP packet). This can be used by IAB-node during IAB-node bootstrapping, migration, IAB-MT RRC resume and IAB-MT RRC re-establishment for E1 traffic or E1AP messages or non-E1 traffic. This channel may be the default BH RLC channel. This may entail the setup of a new BH RLC channel or modification of an existing BH RLC channel between IAB-node 1 and IAB-donor-DU. This phase also may include configuring a backhaul adaptation protocol (BAP) Routing ID for the transfer of E1 traffic or E1AP messages or SCTP/IP or E1 related (SCTP/) IP packet, which may be the default BAP Routing ID. The E1 traffic or E1AP messages or SCTP/IP or E1 related (SCTP/) IP packet may be transferred by using the BH RLC channel and BAP Routing ID used for non-UP traffic or uplink non-UP traffic. The Non-UP Traffic Type may include at least one of: UE-associated F1AP, non-UE-associated F1AP, non-F1, BAP control PDU, UE-associated E1AP, non-UE-associated E1AP, or non-E1, among others.

Under phase 2-2, a routing update may be performed. In this phase, the BAP sublayer may be updated to support routing between the new IAB-node 2 and the IAB-donor-DU. This phase may also include the IP address allocation procedure for IAB-node 2.

### Use of Internet Protocol (IP) Addresses

IAB-node may request one or more IP addresses from the IAB-donor-CU via RRC. The IAB-donor-CU may send one or more IP addresses to the IAB-node via RRC. The IAB-donor-CU may obtain the IP addresses from the IAB-donor-DU via F1-AP or by other means (e.g. OAM or dynamic host configuration protocol (DHCP)).

In some embodiments, the IP address request may be or may be include for each usage, such as all traffic, F1-U, F1-C, non-F1, non-E1, E1 traffic, or NG-U, among others. The non-E1 traffic may refer to the SCTP/IP packet (e.g. Internet Protocol Security (IPsec), stream control transmission protocol (SCTP) messages) between donor CU-CP and IAB-UP. The E1 traffic may refer to the E1AP messages exchanged between donor CU-CP and IAB-UP. The IP address for NG-U may be used by the user plane traffic traversing between IAB-UP and UPF via donor-DU. Upon receiving the request, the IAB-node may be allocated one or multiple IPv6 addresses or one 64-bit IPv6 prefix for each usage or one or multiple IPv4 addresses for each usage. Each allocated IP address or IPv6 prefix may be unique within the IAB network and routable from the wireline network.

In some embodiments, the IAB-node may send the number of requested IP addresses to donor-CU-CP, and may determine the IP addresses used for each usage by itself. Having received the IP addresses, IAB-node may divide the IP addresses into two categories used for DU and UP, separately. However, if IAB-node decides the used IP address, donor-CU may not distinguish the UP related packet from the DU related packet. As such, IAB-node may report the used or determined IP addresses for each usage to donor-CU-CP.

Under phase 3, the IAB-DU part setup may be performed.

Under phase 4, the IAB-UP part setup may be performed. In this phase, the IAB-UP of IAB-node 2 may be configured via OAM. The IAB-UP of IAB-node 2 may initiate the TNL establishment, and E1 setup with the IAB-donor-CU using the allocated IP address(es). The IAB-donor-CU may discover collocation of IAB-MT and IAB-UP from the IAB-node's BAP Address included in the E1AP message, e.g. GNB-CU-UP E1 SETUP REQUEST message. The IAB-donor-CU's IP address communicated with IAB-UP can be sent to IAB-node via a RRC message. In some embodiments, the IAB-UP can discover the IAB-donor-CU's IP address in the same manner as a gNB CU-UP. Donor-CU may update the BH configuration for E1 related messages via E1AP message, e.g. GNB-CU-UP E1 SETUP RESPONSE message., to the IAB-node.

### B. UE Access

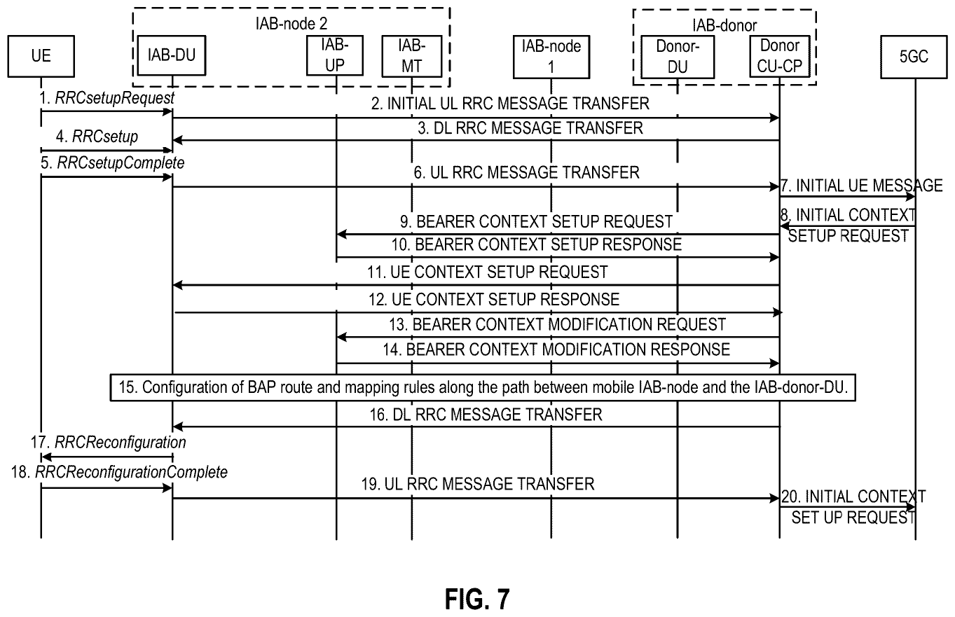

Referring now to FIG. 7, depicted is a communication diagram of a process for a user equipment (UE) to access an integrated access and backhaul (IAB)-node. After IAB node integration procedure, the IAB node may be connected with IAB donor-CU. There may be a UE accessed to the IAB-node. Steps 1-8 may be in accordance with a UE Initial Access procedure.

In step 8, AMF may transparently send donor-CU the UL NG-U UP TNL Information for each PDU session or each GTP tunnel between UPF and IAB-UP. In step 9, the donor-CU-CP may send to the IAB-UP the message, e.g.

BEARER CONTEXT SETUP REQUEST message to establish the bearer context in the IAB-UP. In step 10, the IAB-UP may send the message, e.g. BEARER CONTEXT SETUP RESPONSE message to the donor-CU-CP, including F1-U UL TEID and transport layer address. In step 11, the donor-CU-CP may send the message, e.g. UE CONTEXT SETUP REQUEST message to establish the UE context in the IAB-DU.

In step 12, the gNB-DU (e.g., an IAB-DU) may send the UE CONTEXT SETUP RESPONSE message to the gNB-CU (e.g., IAB-donor CU). The gNB-DU may serve or function as an IAB-DU and the gNB-CU may serve or function as the IAB-donor-CU node. In step 13, the gNB-CU-CP may send the BEARER CONTEXT MODIFICATION REQUEST message to the IAB-UP, including F1-U DL TEID and transport layer address allocated by the gNB-DU. In step 14, the IAB-UP may send the BEARER CONTEXT MODIFICATION RESPONSE message to the gNB-CU-CP. For steps 9˜14, since DU and UP are co-located, the UL or DL tunnel endpoint identifier (TEID) and IP address for each tunnel can be exchanged between DU and UP internally.

In step 15, the donor-CU may configure the BH path. Having received the UP traffic from an UE, the IAB-DU may deliver the UP traffic to the co-located IAB-UP. IAB-UP may retrieve the service data adaptation protocol (SDAP) service data unit (SDU), and further encapsulates it into general packet radio service tunneling protocol user plane (GTP-U), user datagram protocol (UDP), IP. The IP packet may be delivered to the BAP layer at IAB-MT. The traffic traversing the BH path may be at the PDU session level. The PDU session and BH RLC channel could be 1:1 mapping or N:1 mapping.

The BH RLC channel's quality of service (QOS) may be still specified by QoS Flow Level QOS Parameters. Donor CU-CP may send IAB-node (e.g., IAB-MT, DU, or UP) the UL BH info via an E1AP, or an F1AP, or a RRC message. The UL BH information may include at least one of BAP Routing ID, Next-Hop BAP Address, Egress BH RLC channel identifier (CH ID), among others.

In step 16, the donor-CU may generate the RRCReconfiguration message and encapsulate the message in the DL RRC MESSAGE TRANSFER message. In step 17, the mobile-DU may send RRCReconfiguration message to the UE. In step 18, the UE may send RRCReconfigurationComplete message to the mobile-DU. In step 19, the mobile-DU may encapsulate the RRC message in the UL RRC MESSAGE TRANSFER message and send the message to the donor-CU.

In step 20, the donor-CU may send the message (e.g. INITIAL CONTEXT SETUP RESPONSE message) to the AMF, which includes at least one of: a TNL address used for non-UP traffic; port number; a downlink (DL) TNL information (e.g., TNL address, TEID) for each PDU session or each GTP tunnel between UPF and IAB-UP; the mapping between IPsec TNL address and a list of DL GTP Transport Layer addresses; the IP address (e.g., DL GTP TNL address or IPsec TNL address) and/or differentiated services code point (DSCP) and/or flow label configuration on each GTP tunnel between UPF and IAB-UP. The above information would be sent from AMF to UPF.

### C. Mobile IAB-Node Partial Migration

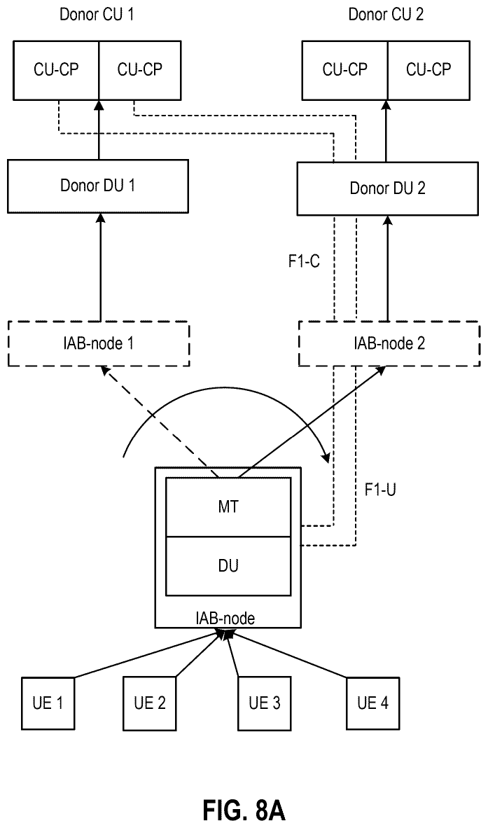

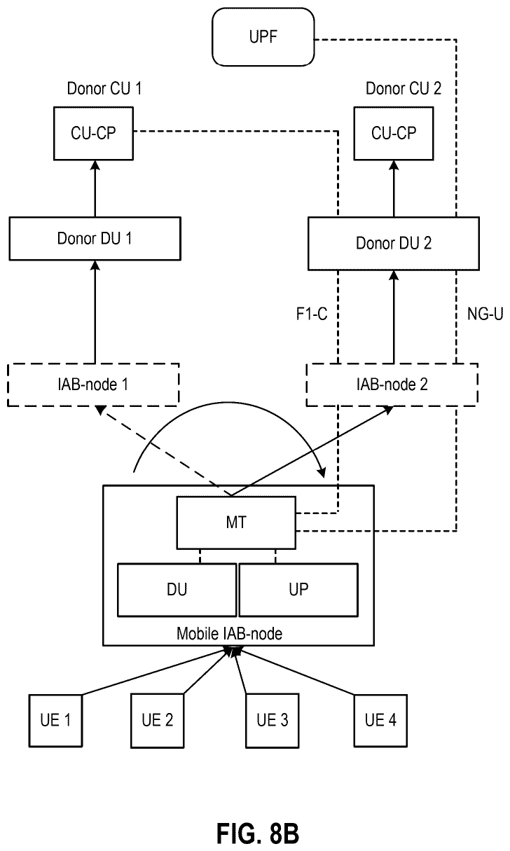

Referring now to FIG. 8A, depicted is a block diagram of a process of a partial migration of a mobile integrated access and backhaul (IAB)-node without a user plane (UP) function. Referring also to FIG. 8B, depicted is a block diagram of a process of a partial migration of a mobile integrated access and backhaul (IAB)-node with a user plane (UP) function. In step 1, the mobile IAB-MT may send a MeasurementReport message to the source parent node IAB-DU. This report may be based on a Measurement Configuration the mobile IAB-MT received from the IAB-donor-CU 1 before. In step 2, the source parent node IAB-DU may send an UL RRC MESSAGE TRANSFER message to the IAB-donor-CU 1 to convey the received MeasurementReport.

In step 3, the source IAB-donor-CU may send an XnAP message to the target IAB-donor-CU, including at least one of the following information: (1) an identity of the mobile IAB-node or the UE; (2) an indication used to indicate the target donor-CU that a mobile IAB-node is going to access; (3) IAB-node capabilities (e.g. whether there is a localized UP); (4) a number of UP function modules localized in the localized in the mobile IAB node; and (5) IP address request for the mobile IAB-node.

In step 4, the target IAB-donor-CU may send a UE CONTEXT SETUP REQUEST message to the target parent node IAB-DU to create the UE context for the migrating IAB-MT and set up one or more bearers. These bearers can be used by the migrating IAB-MT for its own signalling, and data traffic. In step 5, the target parent node IAB-DU may respond to the target IAB-donor-CU with a UE CONTEXT SETUP RESPONSE message. In step 6, the target IAB-donor-CU may perform admission control and provide the new RRC configuration as part of the XnAP message. Target donor-CU may send the XnAP message to source donor-CU.

In step 7, the source IAB-donor-CU may send a UE CONTEXT MODIFICATION REQUEST message to the source parent node IAB-DU, which includes the received RRCReconfiguration message from the target IAB-donor-CU. In step 8, the source parent node IAB-DU may forward the received RRCReconfiguration message to the mobile IAB-MT. In step 9, the source parent node IAB-DU responds to the source IAB-donor-CU with the UE CONTEXT MODIFICATION RESPONSE message. In step 10, a random access procedure may be performed at the target parent node IAB-DU.

In step 11, the mobile IAB-MT may respond to the target parent node IAB-DU with an RRCReconfigurationComplete message. In step 12, the target parent node IAB-DU may send an UL RRC MESSAGE TRANSFER message to the target IAB-donor-CU to convey the received RRCReconfigurationComplete message. After receiving the RRCReconfigurationComplete message, target CU-CP may send an indication to source CU-CP. The indication may be used to inform source CU-CP of the success access of mobile IAB-node. The mobile IAB-node may indicate source CU-CP about the successful access by the mobile IAB-node.

In step 13, the F1-C connection between the migrating IAB-node and the source IAB-donor-CU may be switched to the target path using the new TNL address information of the migrating IAB-node. The migrating IAB-node may report the new TNL address information it wants to use for F1-C or non-F1 traffic to the source IAB-donor-CU via F1AP messages. The new TNL address information may include IP address or port number.

The E1 connection between the migrating IAB-node and the source IAB-donor-CU may be switched to the target path using the new TNL address information of the migrating IAB-node. The migrating IAB-node may report the new TNL address information to use for E1 and non-E1 traffic to the source IAB-donor-CU. The new TNL address information may include IP address or port number.

If F1-U tunnel is established between IAB-DU and IAB-UP, the F1-U connections of IAB-DU with IAB-UP may be switched to the migrating IAB-node's new TNL addresses. If IPsec is not enabled between IAB-DU and IAB-UP, the new TNL address is GTP TNL address. IAB-DU and IAB-UP may acquire the new TNL address of the other side. In some embodiments, the IAB-DU or IAB-UP may report the new TNL address information to use for each F1-U tunnel to the source or target IAB-donor-CU. The new TNL address information may include IP address or GTP-TEID.

Other, if the IPsec is enabled between the IAB-DU and IAB-UP, the new TNL address may include an IPsec TNL address. IAB-DU and IAB-UP may acquire the new TNL address of the other side. In some embodiments, IAB-DU or IAB-UP may report the mapping between new IPsec TNL address and GTP Transport Layer Addresses to donor-CU-CP. If inner IP address (e.g., GTP Transport Layer Address) is changed, the IAB-DU or IAB-UP may report the inner TNL address information to use for each F1-U tunnel to the source or target IAB-donor-CU. The inner TNL address information may include IP address or GTP-TEID. All the information mentioned above may be sent via a F1AP, E1AP, or RRC message.

In step 14, the source IAB-donor-CU may send an XnAP message to the target IAB-donor-CU. The message can be UE-associated message or a non-UE-associated message, including at least one of the following information: (1) Mobile IAB-node identity; (22) traffic index (or of a plurality of traffic indices); and (3) traffic profile, including QoS parameters for UP traffic or non-UP traffic; and (4) UE identity. The non-UP traffic information may be indicated as {UE-associated E1AP, non-UE-associated E1AP, non-E1 . . . }, or the priority of the non-UP traffic. This can occur at the end of or after step 12.

In step 15, the target IAB-donor-CU may configure BH RLC channels and BAP-sublayer routing entries on the target path between the target parent IAB-node and target IAB-donor-DU as well as DL mappings on the target IAB-donor-DU for the migrating IAB-node's target path. In step 16, target CU-CP may send an XnAP message to source CU-CP, including Mobile IAB-node identity and BH configuration. The QoS mapping information including the DSCP or IPv6 Flow Label values may be sent to source CU-CP as well.

In step 17, the source IAB-donor-CU may provide to the IAB-UP of the migrating IAB-node the updated UL BH information based on the UL BH information received from the target IAB-donor-CU in step 16. The source IAB-donor-CU may also update the UL BH information associated with non-UP traffic (e.g. non-E1 or E1 traffic). This step may use UE associated signaling or non-UE associated signaling in E1 or F1 interface. In step 18, the UPF may acquire the new DL TNL information and/or the new QoS mapping info in order to encapsulate the DL packet terminated at the mobile IAB-node.

In some embodiments, source CU-CP may send the requirements to UPF via AMF. After obtaining the new DL TNL information and the new QoS mapping info, source CU-CP can send these configurations to UPF. The configuration may be transparently forwarded by AMF to UPF. A new NG application protocol (NGAP) message may be defined to inform AMF the updated DL TNL info and the QoS mapping info. The message may include the following.

If IPsec is not enabled, the message may include: (1) previous GPRS tunneling protocol (GTP) transport layer information; (2) new GPRS tunneling protocol (GTP) transport layer information; and (3) QoS mapping information, including the DSCP or IPv6 Flow Label values. Otherwise, if IPsec is enabled, the message may include: (1) old TNL information including inner IP address (e.g., GTP Transport Layer Address); (2) new TNL info, including includes inner IP address (e.g., GTP Transport Layer Address); (3) new IPsec TNL address; (4) old IPsec TNL address; and (5) mapping between IPsec TNL address and a list of GTP TNL addresses. Here, the GTP TNL address can be old or new inner IP address. The TNL information or GPRS tunneling protocol (GTP) transport layer information may include IP address and/or GTP-TEID. The TNL information or GPRS tunneling protocol (GTP) transport layer information may be named as DL QOS Flow per TNL Information, or DL TNL Information or NG DL UP Transport Layer Information.

The TNL information or GPRS tunneling protocol (GTP) transport layer information may be associated with a PDU Session ID. The TNL information or GPRS tunneling protocol (GTP) transport layer information may correspond to UL TNL info or UL GPRS tunneling protocol (GTP) transport layer information, or DL TNL information or DL GPRS tunneling protocol (GTP) transport layer information.

In some embodiments, target CU-CP may send the configuration to UPF via AMF. Source CU-CP may send the following info to target CU-CP: (1) traffic index, associated with a PDU session (ID) or an UL or DL TNL information or UL/DL GPRS tunneling protocol (GTP) transport layer information; (2) a PDU session identity; (3) UL TNL info or UL GPRS tunneling protocol (GTP) transport layer information, or DL TNL information or DL GPRS tunneling protocol (GTP) transport layer information. The TNL information may include inner IP address, IPsec TNL address, or GTP-TEID, or port number. The target CU-CP may send the requirements to AMF via a new defined NGAP message or reuse the PATH SWITCH procedure associated with the mobile IAB-MT.

In step 19, the target IAB-donor-CU may trigger the path switch procedure for the migrating IAB-MT. In step 20, the target IAB-donor-CU may send UE CONTEXT RELEASE message to the source IAB-donor-CU. In step 21, the source IAB-donor-CU may release BH RLC channels and BAP-sublayer routing entries on the source path between source parent IAB-node of the migrating IAB-node and the source IAB-donor-DU.

### D. Full Migration of Mobile IAB-Node

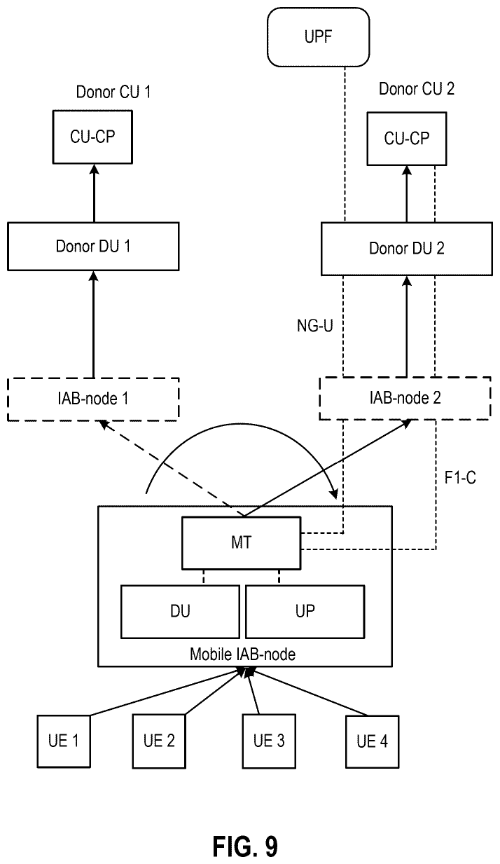

Referring now to FIG. 9, depicted is a block diagram of a process of a full migration of a mobile integrated access and backhaul (IAB)-node with a user plane (UP) function. IAB-node may receive IP addresses routable via the target IAB-donor-DU and the identity or BAP address of the target donor-DU. After IAB-MT has acquired the IP addresses routable via the target IAB-donor-DU and has performed random access procedure, IAB-UP may perform E1 setup with donor 2 CU-CP. Then, BH configuration may be sent from donor 2 CU-CP to IAB-UP, including BH RLC channel configuration, routing configuration, and bearer mapping configuration. The target CU-CP may send the following information to UPF via AMF: (1) new DL GTP TNL information for each NG-U tunnel, including IP address and TEID (e.g., If IPsec is enabled, the IP address may correspond to the inner IP address); (2) in case of IPsec enabling, the IPsec TNL address; and (3) QoS mapping information for each NG-U tunnel.

If IPsec is not enabled, the information may include: (1) previous GPRS tunneling protocol (GTP) transport layer information; (2) new GPRS tunneling protocol (GTP) transport layer information; (3) QoS mapping information, including the DSCP or IPv6 Flow Label values. Otherwise, the information may include: (1) old TNL information, which includes inner IP address (e.g., GTP Transport Layer Address); (2) new TNL information including inner IP address (e.g., GTP Transport Layer Address); (3) new IPsec TNL address; (4) Old IPsec TNL address; and (5) the mapping between IPsec address and a list of GTP TNL addresses. Here, the GTP TNL address can be old or new inner IP address.

The TNL information or GPRS tunneling protocol (GTP) transport layer information may include IP address or GTP-TEID. The TNL information or GPRS tunneling protocol (GTP) transport layer information may correspond to DL QoS Flow per TNL Information, or DL TNL Information or NG DL UP Transport Layer Information. The TNL information or GPRS tunneling protocol (GTP) transport layer information may be associated with a PDU Session ID. The TNL information or GPRS tunneling protocol (GTP) transport layer information may refer to UL TNL info or UL GPRS tunneling protocol (GTP) transport layer information or DL TNL info or DL GPRS tunneling protocol (GTP) transport layer information.

The E1 setup procedure may come with service interruption. To mitigate the interruption, IAB-node can be implemented two IAB-UPs. This can be regarded as a logical-UP concept. During full migration procedure, at least after IAB-MT receives the IP addresses routable via the target IAB-donor-DU, the original IAB-UP may be serving UEs while the other IAB-UP is establishing E1 interface with target donor CU-CP.

The target donor CU-CP may configure new IP addresses to IAB-node. The target donor CU-CP or source donor CU-CP may explicitly indicate that the IP addresses is used for the IAB-UP, which may establish E1 connection with target donor CU-CP. Target donor CU-CP or source donor CU-CP may configure a BAP address to IAB-node, and indicate IAB-node that the BAP address refers to the IAB-UP which may establish E1 connection with target donor CU-CP. The IAB-MT may know which IAB-UP a DL packet is to be delivered to according to the BAP address.

Some steps detailed herein in conjunction with FIGS. 9A and 9B may be also applicable to the steps discussed in FIG. 9. Information exchanged between donor CU-CPs, or between donor CU-CP and 5GC (e.g. AMF or UPF), or between donor CU-CP and IAB-DU, IAB-MT, or IAB-UP, may also applicable to steps in FIG. 9.

### E. Process for Configuring IAB Nodes

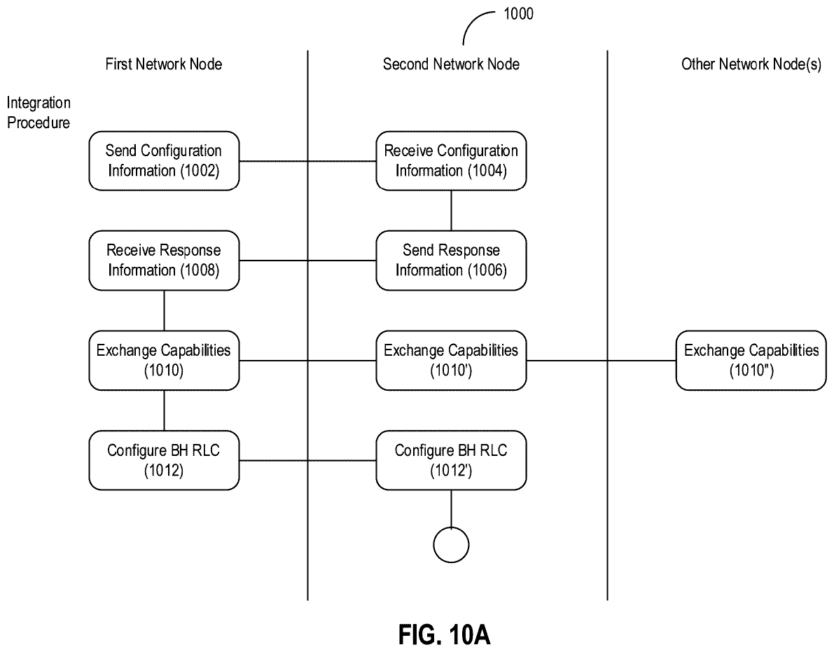

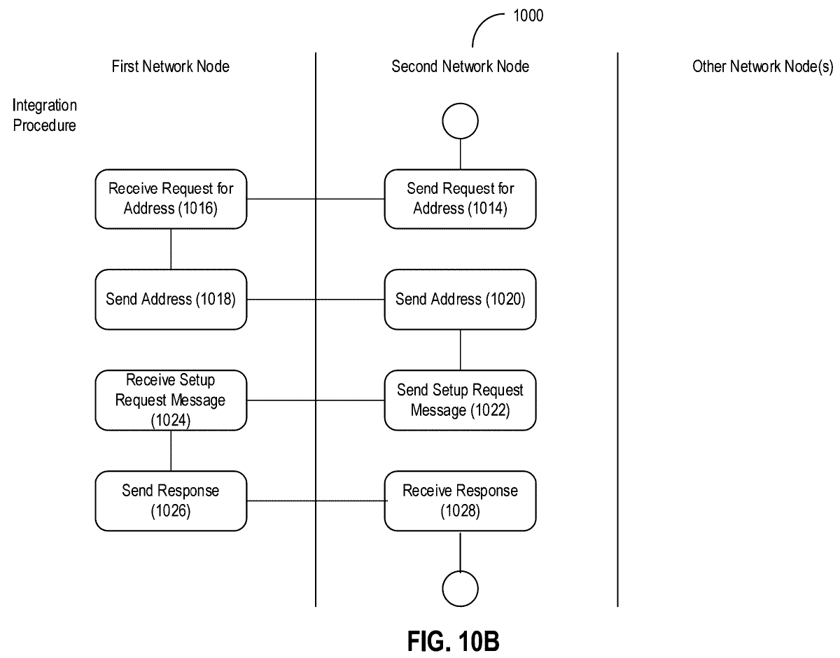

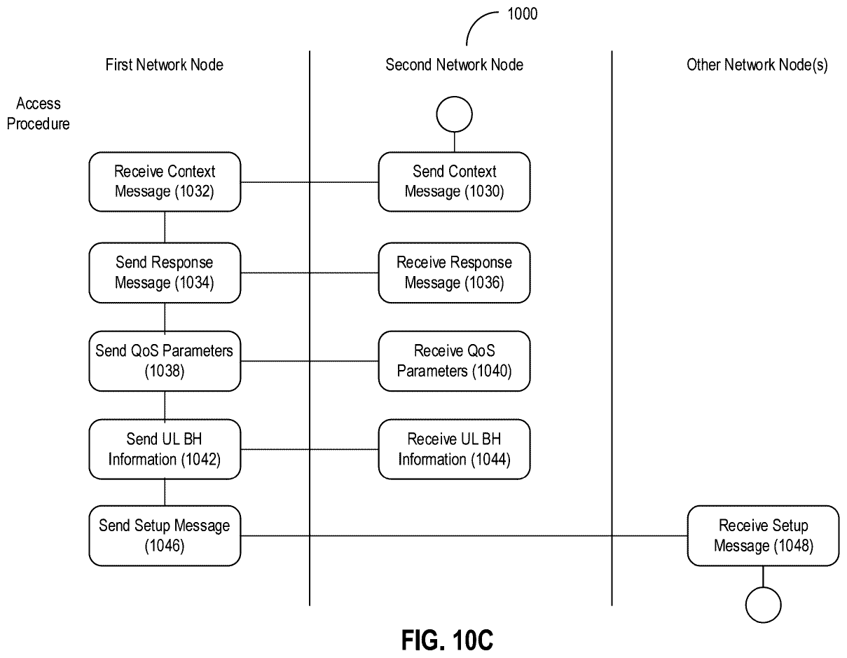

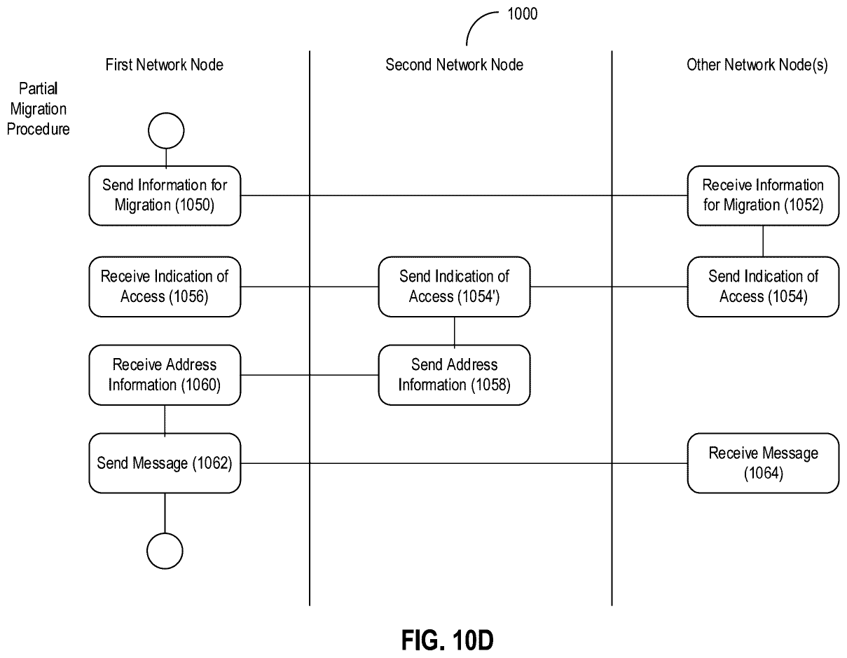

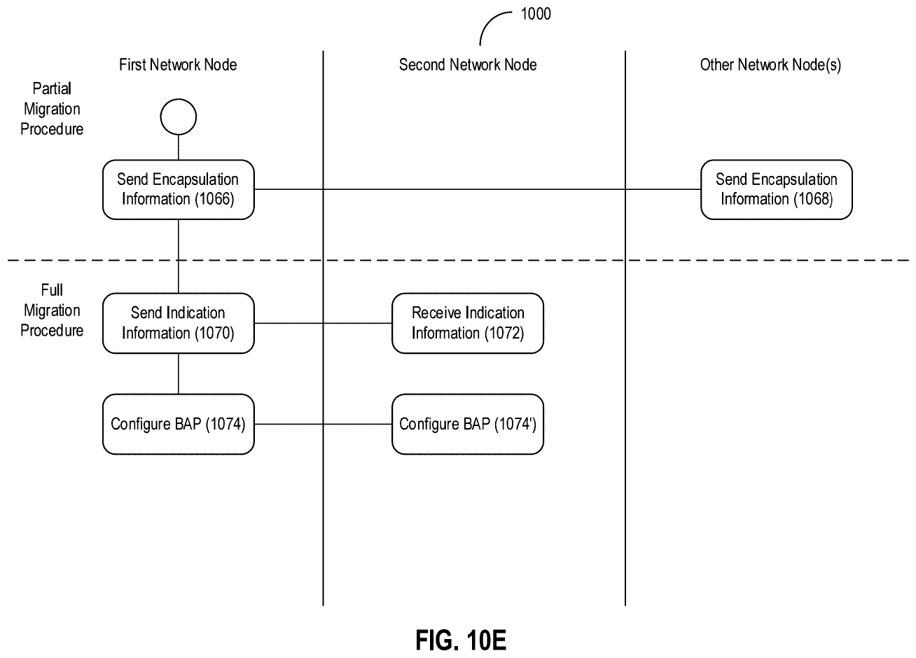

Referring now to FIGS. 10A-E, depicted is a flow diagram of a method 1100 of configuring mobile relay or integrated access and backhaul (IAB)-nodes. The functions and operations of the method 1100 may be performed by any of the components detailed herein, such as any of the IAB nodes. A first network node (e.g., an IAB donor CU) may provide, transmit, or otherwise send configuration information to a second network node (1002). The configuration information may be to initiate an integration process between the first network node and the second network node. The configuration information may correspond to or may be associated with a node that is capable of providing at least one user plane (UP) function. The node may correspond to the first network node, the second network node, or any IAB node that is capable of providing the UP function. The node may correspond to the first network node, the second network node, or any IAB node that is capable of providing the UP function. The UP function may provide various functionalities, such as: an interconnect point between a mobile infrastructure and a data network (e.g., general packet radio service tunneling protocol for user plane (GTP-U), an anchor point for a protocol data unit (PDU) session for supporting mobility, packet routing and forwarding in PDU sessions, per-flow quality of service (QOS) handling for uplink (UL) and downlink (DL), among others. The network nodes may be IAB nodes. In some embodiments, the at least one UP function may include a gNB centralized unit UP (gNB-CU-UP) function. The second network node may retrieve, identify, or otherwise receive the configuration information from the first network node (1004). In some embodiments, the second network node may be or may include the node, a mobile termination (MT) function of the node, a distributed unit (DU) of the node, or the UP function of the node.

The second network node may provide, transmit, or otherwise send response (or setup) information to the first network node (1006). The second network node to provide the response information may be an IAB-MT node. The response information may identify or include any one or more of: an indication of whether the second network node is a mobile node; an indication of whether the second network node is capable of providing the at least one UP function; or a number of UP function modules localized in the second network node. The first network node may retrieve, identify, or otherwise receive the response (setup) information from the second network node (1008).

The first network node may exchange capabilities with the second network node or one or more other network nodes (1010, 1110′, and 1110″). The capabilities may be with respect to supporting the at least one UP function or allowing access to the node capable of providing the UP function. The exchanging of the capabilities may be performed in conjunction with the integration of the second network node. In some embodiments, the first network node may provide, transmit, or otherwise send information on the first network node's capability of supporting communication with the node that is capable of providing the UP function. In some embodiments, the first network node may send the information on allowing access of the node capable of providing the UP function. The information may be sent by the first network node to the second network node.

In some embodiments, a parent node (e.g., the parent IAB node) of the second network node may send, transmit, or otherwise broadcast information on the first network node's capability of supporting communication with the node that is capable of providing the at least one UP function. The information may identify or indicate whether the first network node is capable of supporting communication with the node that provides the UP function. In some embodiments, the parent node of the second network node may broadcast information on allowing access of the node capable of providing the at least one UP function. The information may identity or indicate whether access to the node that is capable of providing the UP function is allowed.

In some embodiments, the first network node may provide, transmit, or otherwise send to a third network node (e.g., an access and mobility function (AMF)) the second network node's capability of whether the UP function is supported. In some embodiments, the third network node may provide, transmit, or otherwise send an indication of whether the second network node is authorized to provide support for the UP function. The first network node may in turn retrieve, identify, or otherwise identify the indication of whether the second network node is authorized to provide support of the UP function.

In some embodiments, the first network node may exchange the capabilities of whether the first or the third network node can serve as the node capable of providing the UP function. The exchanging may be performed before, after, or during the integration of the second network node. In some embodiments, the first network node may exchange the capabilities of whether the third or fourth network node can serve as the node capable of providing the UP function. The fourth network node may be, for example, a node for the UP function.

The first network node may configure backhaul (BH) radio link control (RLC) for carrying traffic between the first network node and the UP function of the second network node (1012 and 1112′). In some embodiments, the first network node may establish or modify the BH RLC for carrying traffic between the first network node and the UP function on the second network node. In some embodiments, the first network node may set, assign, or otherwise configure the backhaul adaptation protocol (BAP) routing identifier (ID) for the traffic between the first network node and the UP function of the second network node.

The traffic between the first network node and the UP function for the second network node may be communicated, exchanged, or otherwise transferred using the BH RLC channel and the BAP routing ID used for non-UP traffic or uplink non-UP traffic. A traffic type of the non-UP traffic may include at least one of: UE-associated F1 application protocol (F1CP), a non-UE associated F1AP, non-F1, among others. The traffic type may also include BAP control PDU. The traffic type may also include, for example, UE-associated E1 application protocol (E1AP), non-UE-associated E1AP, or non-E1, among others. In some embodiments, the traffic between the first network node and the second network node may include one or more of non-UP traffic, E1 traffic, or non-E1 traffic.

The second network node may provide, transmit, or otherwise send a request for address to the first network node (1014). The request may be for each usage of a set of usages with respect to traffic, such as usage of all traffic, F1 user plane interface (F1-U) traffic, F1 control plane interface (F1-C) traffic, non-F1 traffic, non-F1 traffic, or user plane traffic via an NG-U interface, among others. In some embodiments, the request may define, specify, or otherwise identify a number of IP addresses requested or a number of IP addresses used for each usage, among others. The first network node may retrieve, identify, or otherwise receive the request for address from the second network node (1016). Upon receipt, the first network node may parse the request for address to identify each usage for which an address is requested. In some embodiments, the first network node may retrieve, identify, or otherwise receive the number of IP addresses requested or the number of IP addresses to be used for each usage. The first network node may serve or function as an IAB donor-CU-UP in receiving the number of IP addresses requested by the second network node.

The first network node may provide, transmit, or otherwise send one or more addresses to the second network node (1018). The sending of the addresses may be responsive to the receipt of the request. The address may be one or more of: an IPv6 address or a 64-bit IPv6 prefix for each usage. In some embodiments, the address may include one or more IPv4 addresses for each of the usages. The first network node may send the number of IP addresses (e.g., IPv6 or 64-bit IPv6 prefix for each usage) as requested by the second network node. The second network node may retrieve, identify, or otherwise receive the one or more addresses from the first network node (1020). In some embodiments, the second network node may store and maintain the addresses received from the first network node.

The second network node may provide, transmit, or send a setup request message (e.g., a GNB-CU-UP E1 SETUP REQUEST message) (1022). The setup request message may be communicated via a message from the UP function of the second network node, and may include the BAP address. The first network node in turn may retrieve, identify, or receive the BAP address via the setup request message from the second network node (1024). Upon receipt, the first network node may parse the setup request message to identify or extract the BAP address.

Using the setup request message, the first network node may provide, transmit, or otherwise send a response to the second network node (1026). In some embodiments, the first network node may provide, transmit, or send an IP address to the second network node. In some embodiments, the first network node may send a BH configuration for the traffic between the first network node and the UP function of the second network node. In turn, the second network node may retrieve, identify, or otherwise receive the response from the first network node (1028). The second network node may parse the response to identify the IP address or the BH configuration for the traffic between the first network node and the UP function.

The second network node may provide, transmit, or otherwise send a context message (e.g., BEARER CONTEXT SETUP RESPONSE message) to the first network node (1030). The context message may identify or include an F1 user plane interface (F1-U) uplink (UL) tunnel endpoint identifier (TEID) or a transport layer address, among others. The first network node may function as the IAB donor-CU-CP node in receiving the context message, and the second network node's UP function may generate and send the context message. The transmission of the context message may be a part of an access procedure in a user equipment (UE) is to access an IAB node. The first network node in turn may retrieve, identify, or otherwise receive the context message from the second network node (1032). Upon receipt, the first network node may parse the context message to identify the F1-U UL TEID or the transport layer address. The first network node may provide, transmit, or otherwise send a response message to the second network node (1034). The response may be responsive to the context message from the second network node. The response message may identify or include at least one of: F1-U downlink (DL) TEID or a transport layer address (e.g., of the IAB-DU node). The UP function of the second network node may in turn retrieve, identify, or receive the response from the first network node.

The first network node may provide, transmit, or otherwise send quality of service (QOS) flow level QoS parameters to the second network node (1038). The QoS parameters may be of the backhaul (BH) radio link control (RLC) channel. The QoS may be for the PDU session between the first network node and the second network node. In some embodiments, a protocol data unit (PDU) session and a BH RLC channel may have a one-to-one (1:1) mapping or a many-to-one (N:1) mapping. The second network node may retrieve, identify, or receive the QoS flow level QoS parameters from the first network node (1040).

The first network node may provide, transmit, or otherwise send uplink (UL) backhaul (BH) information to the second network node (1042). The uplink BH information may identify or include one or more of: a backhaul adaptation protocol (BAP) protocol routing identifier (ID), a next-hop BAP address, or an ID of an egress BH RLC channel, among others. The second network node may in turn retrieve, identify, or otherwise receive the uplink BH information from the first network node (1044). With receipt, the second network node may parse the BH information identify the BAP protocol routing ID, the next-hop BAP address, or the ID of the egress BH RLC channel.

The first network node may provide, transmit, or otherwise send a setup message to a third network node (e.g., an access and mobility function (AMF)) (1046). The setup message may include or identify information for the AMF. In some embodiments, the information may identify or include a mapping between an IP security (IPsec) transport layer address and a list of an uplink or downlink GPRS tunneling protocol (GTP) transport layer address, among others. In some embodiments, the information may identify or include at least one of an IP address, a differentiated services code point (DSCP) or a flow label configuration, on each protocol data unit (PDU) session or GTP tunnel between an UP function of the second network node and a core network, among others. The third network node may in turn retrieve, identify, or otherwise receive the setup message from the first network node (1048). The third network node may provide, transmit, or otherwise send the information to another fourth network node (e.g., a UP function node). The third network node and the fourth network node each may be a network function or an entity of the core network.

The first network node may provide, transmit, or otherwise send information (e.g., XnAP message) for migration to a third network node (1050). The transmission of the information may be as part of a partial migration procedure. The first network node may serve or function as a source or original IAB donor CU or donor-CU-CP. The second network node may serve or function as the IAB node. The third network node may serve or function as a IAB target donor-CU or donor-CU-CP. The information may identify or include one or more of: an identity of the second network node or a UE; an indication of whether the second network node is a mobile node; an indication of a capability of the second network node to provide the UP function; or a number of UP function modules localized in the second network node, among others. The third network node may in turn retrieve, identify, or otherwise receive the information for migration from the first network node (1052).

The second network node may provide, transmit, or otherwise send an indication of successful access by the second network node to inform the first network node (1054). In some embodiments, the third network node may transmit the indication of success access by the second network node to inform the first network node (1054′). The indication may be via higher layer signaling, such as radio resource control (RRC) (e.g., UL RRC Message Transfer Message). The first network node may retrieve, identify, or otherwise receive the indication of the successful access by the second network node from the second network node itself or the third network node (1056).

The second network node may provide, transmit, or otherwise send at least one address information to the first network node (1058). In some embodiments, the second network node may send transport network layer (TNL) address information to the first network node. The TNL address information may identify or include one or more of: an IP address or a port number. The IP address or the port number may be used for F1 control plane interface (F1-C) traffic, non-F1 traffic, E1 traffic, non-E1 traffic, or non-UP traffic, among others. In some embodiments, the second network node may provide, transmit, or otherwise send a mapping between the IPsec transport layer address and at least one GPRS tunneling protocol (GTP) transport layer address to the first network node. In some embodiments, the second network node may provide, transmit, or otherwise send a GTP transport layer information. The GTP address information may identify or include one or more of: an IP address or a TEID.

The first network node may in turn retrieve, identify, or otherwise receive the address information from the second network node (1060). In some embodiments, the first network node may receive the TNL address information from the second network node. With receipt, the first network node may parse the TNL address information to identify or extract the IP address or the port number for use. In some embodiments, the first network node may receive the mapping between the IPsec transport layer address and the GTP transport layer. In some embodiments, the first network node may receive the GTP transport layer information. With respect to GTP, the first network node may function or serve as an IAB donor-CU-CP and the second network node may function or serve as an IAB donor-DU or IAB-UP node.

The first network node may provide, transmit, or otherwise send at least one message to the third network node (1062). The message may include information. The information may be associated with the second network node, such as an identity of the second network node, an indication of the second network node which is a mobile node, among others. The information may be related to traffic, such as a traffic index of a plurality of traffic indices or a traffic profile including QoS parameters for UP traffic and non-UP traffic, among others. In some embodiments, the information in the message may identify an identity of the UE. The third network node in turn may retrieve, identify, or receive the message from the first network node. The third network node may parse the information from the message. The first network node may provide, transmit, or otherwise send uplink backhaul (BH) information to the UP function of the second network node. The BH information may be based on the BH information from the third network node or associated with non-UP traffic.

The first network node may provide, transmit, or otherwise send a message with encapsulation information (1066). In some embodiments, the information may be sent to a fourth network node (e.g., a UP function) via a fifth network node (e.g., an AMF). In some embodiments, the information may be sent to the fifth network node directly. The information may include or identify one or more of: an identity of the second network node or the UE; uplink (UL) or downlink (DL) TNL information; a QoS mapping information, or an identity of a PDU session, among others. In some embodiments, the UL or DL TNL information may identify or include one or more of: a previous GPRS tunneling protocol (GTP) transport layer address information, a new GTP transport layer address information, a new IPsec TNL address, or a mapping between an IPsec TNL address and a list of GPRS tunneling (GTP) addresses, among others. The previous or new GTP transport layer address information may include or identify one or more of an IP address or a GTP TEID, among others. In some embodiments, the QoS mapping information may identify or include an IP address, a differentiated services code point (DSCP), or flow label values, among others.

In some embodiments, the first network node may send a message with specification information to the third network node. The first network node may function or serve as a source IAB CU-UP and the third network node may function or serve as a target IAB donor-CU-UP node. The information may identify or include a traffic index, which associates with a packet data unit (PDU) session or a PDU session identifier or an uplink or downlink TNL information; an identity of a PDU session, or the UL or DL TNL information, among others. In some embodiments, the TNL information may identify or include at least one of an IP address, TEID, or a port number, among others. The fifth network node may in turn retrieve, identify, or otherwise receive the encapsulation information (1068).

Continuing on, the first network node may transmit, provide, or otherwise send indication information to the second network node (1070). The sending of the information may be a part of the full migration procedure of the second network node. The first network node may function or serve as a source or target IAB donor-CU-CP node and the second network node may function or serve as an IAB UP node. The information may be associated with an IP address and may include or identify: at least one IP address; an indication that an IP address is to be used by the second network node to establish an E1 connection with a third network node; and an indication that the IP address is allocated by the third network node, among others. The information may also be associated with a BAP address and may include or identify: a BAP address allocated by the third network node, an indication that the BAP address is allocated by the third network node, or a BAP address of a fourth network node (e.g., a target IAB donor-DU) controlled by the third network node, among others. The second network node may in turn retrieve, identify, or receive the indication information from the first network node (1072).

In some embodiments, the first network node may set, assign, or otherwise configure a BAP address for the second network node (1074 and 1174′). In some embodiments, the first network node may provide or send the BAP address. In some embodiments, the first network node may provide or send an indication that a packet with the BAP address is communicated with the UP function to establish an E1 connection with the third network node.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method, comprising:
sending, by a first network node to a second network node, configuration information,
wherein the configuration information is associated with a node capable of providing at least one user plane (UP) function.

2. The method of claim 1, wherein:
the at least one UP function includes a gNB centralized unit UP (gNB-CU-UP) function.

3. The method of claim 1, wherein the second network node includes at least one of: the node, a mobile termination (MT) function of the node, a distributed unit (DU) function of the node, or a UP function of the node.

4. The method of claim 1, comprising:
receiving, by the first network node from the second network node, first information comprising at least one of: an indication of the second network node which is a mobile node,
an indication or a capability of the second network node to provide the at least one UP function, or a number of UP function modules localized in the second network node.

5. The method of claim 1, wherein a parent node of the second network node broadcasts information on the first network node's capability of supporting communication with the node capable of providing the at least one UP function, or information on allowing access of the node capable of providing the at least one UP function.

6. The method of claim 1 comprising at least one of:
sending, by the first network node to the second network node, the first network node's capability of supporting communication with the node capable of providing the at least one UP function, or info on allowing access of the node capable of providing the at least one UP function;
sending, by the first network node to a third network node, the second network node's capabilities which include whether the at least one UP function is supported;
receiving, by the first network node from the third network node, an indication of whether the second network node is authorized to provide of support the at least one UP function;
exchanging, by the first network node with the third network node before, after or during integration of the second network node, capabilities that include whether the first or third network node can serve the node capable of providing the at least one UP function; or
exchanging, by the third network node with the fourth network node before, after or during the integration of the second network node, capabilities that include whether the third or fourth network node can serve the node capable of providing the at least one UP function.

7. The method of claim 1, wherein at least one of:
the first network node establishes or modifies a backhaul (BH) radio link control (RLC) for carrying traffic between the first network node and a UP function of the second network node;
the first network node configures a backhaul adaptation protocol (BAP) routing identifier (ID) for traffic between the first network node and the UP function of the second network node;
traffic between the first network node and the UP function of the second network node is transferred using the BH RLC channel and the BAP routing ID used for non-UP traffic or uplink non-UP traffic; or a traffic type of the non-UP traffic includes at least one of: UE-associated F1 application protocol (F1AP), non-UE-associated F1AP, non-F1, BAP control PDU, UE-associated E1 application protocol (E1AP), non-UE-associated E1AP, or non-E1.

8. The method of claim 7, wherein the traffic between the first network node and the UP function of the second network node includes at least of: non-UP traffic, E1 traffic, or non-E1 traffic.

9. The method of claim 1, comprising:
receiving, by the first network node from the second network node, a request for at least one IP address, wherein the request is for each of a plurality of usages comprising at least one of: all traffic, F1 user plane interface (F1-U) traffic, F1 control plane interface (F1-C) traffic, non-F1 traffic, non-E1 traffic, E1 traffic, or user plane traffic via an NG-U interface; and
sending, by the first network node to the second network node, at least one of: one or more IPv6 addresses or one 64-bit IPv6 prefix for each of the usages, or one or more IPv4 addresses for each of the usages.

10. The method of claim 1, comprising:
receiving, by the first network node from the second network node, at least one of: a number of IP addresses requested, or a number of IP addresses used for each of a plurality of usages.

11. The method of claim 1, comprising at least one of:
receiving, by the first network node, a backhaul adaptation protocol (BAP) address via a message from a UP function of the second network node;
sending, by the first network node to the second network node, an IP address of the first network node; or sending, by the first network node to the second network node, a backhaul (BH) configuration for traffic between the first network node and the UP function of the second network node.

12. The method of claim 1, comprising:
receiving, by the first network node from the second network node, a first message comprising at least one of: an F1 user plane interface (F1-U) uplink (UL) tunnel endpoint identifier (TEID) or a transport layer address.

13. The method of claim 12, comprising:
sending, by the first network node to the UP function of the second network node, a second message comprising at least one of: a F1-U DL TEID or a transport layer address.

14. The method of claim 1, comprising:
sending, by the first network node, quality-of-service (QOS) flow level QoS parameters of the backhaul (BH) radio link control (RLC) channel.

15. The method of claim 14, wherein a protocol data unit (PDU) session and a BH RLC channel has a one-to-one mapping or a many-to-one mapping.

16. The method of claim 1, comprising:
sending, by the first network node to the second network node, uplink backhaul (BH) information, wherein the
uplink BH information includes at least one of a backhaul adaptation protocol (BAP) routing identifier (ID), a next-hop BAP address, or an ID of an egress BH RLC channel.

17. The method of claim 1, comprising:
sending, by the first network node to a third network node, a message with information comprising at least one of: a mapping between an IP security (IPsec) transport layer address and a list of an uplink or downlink GPRS tunneling protocol (GTP) transport layer address, or
at least one of an IP address, a differentiated services code point (DSCP) or a flow label configuration, on each protocol data unit (PDU) session or GTP tunnel between an UP function of the second network node and a core network.

18. The method of claim 17, wherein the information is sent from a third network node to a fourth network node, wherein the third network node and the fourth network node each is a network function or an entity of the core network.

19-31. (canceled)

32. A method, comprising:
receiving, by a second network node from a first network node, configuration information,
wherein the configuration information is associated with a node capable of providing at least one user plane (UP) function.

33. (canceled)

34. A wireless communication device comprising a memory for storing instructions and at least one processor configured to execute the instructions to:
send, by a first network node to a second network node, configuration information;
wherein the configuration information is associated with a node capable of providing at least one user plane (UP) function.
